(19) United States
(12) Patent Application Publication
(10) Pub. No.: US 2015/0138082 A1
(43) Pub. Date: May 21, 2015

(54) IMAGE DISPLAY APPARATUS AND IMAGE DISPLAY SYSTEM

(71) Applicant: SHARP KABUSHIKI KAISHA, Osaka-shi, Osaka (JP)

(72) Inventor: Yoshinori Nagata, Osaka-shi (JP)

(21) Appl. No.: 14/406,384

(22) PCT Filed: May 30, 2013
(86) PCT No.: PCT/JP2013/065005

§ 371 Date: Dec. 8, 2014

(30) Foreign Application Priority Data
Jun. 28, 2012 (JP) 2012-145106

(51) Int. Cl. G06F 3/033

(52) U.S. Cl. CPC G06F 3/033
USPC 345/157

(57) ABSTRACT

An image display apparatus 200 includes a display unit 210, a communication IF unit 218 and a CPU 202. When the communication IF unit 218 receives data representing that an external device is operated, CPU 202 displays a corresponding cursor on the display unit 210. If the communication IF unit 218 does not receive in a prescribed time period data representing that the external device operated, the CPU 202 erases the corresponding cursor from the display unit 210. When the communication IF unit 218 receives an instruction of special display from an external device, the CPU 202 displays a corresponding cursor in a special manner on the display unit 210. Thus, a cursor that is not operated for a prescribed time period can automatically be erased, and it is possible to display a cursor in a special manner.

### TECHNICAL FIELD

The present invention relates to an image display apparatus used for conference, presentation and the like and, more specifically, to an image display apparatus and an image display system in which a cursor displayed on a screen is operable from an external device.

### BACKGROUND ART

Recently, as one type of touch drawing image display apparatus, electronic blackboards used for conference and the like of various configurations come to be practically used. Particularly, an electronic blackboard apparatus configured as a computer system including a combination of an image display apparatus having a large display screen and an input device such as a touch-panel for detecting two-dimensional positional coordinates is used. A large electronic blackboard is also used, for example, for presentation.

Generally, an electronic blackboard apparatus successively reads pieces of information related to position coordinates designated by a pen or the like and pieces of information related to amount of movement, and displays a track of inputs on the display device based on the read pieces of information. Thus, the apparatus can realize operations as an electronic blackboard such as handwriting input.

A technique of operating an electronic blackboard apparatus by displaying a cursor (hereinafter also referred to as a pointer) on the display screen of electronic blackboard apparatus for designating, for example, an object of control on the screen, in accordance with information input from an external device, has been known. It is also possible to display cursors simultaneously on the display screen of the electronic blackboard apparatus from a plurality of external devices. By way of example, Japanese Patent Laying-Open No. 3-257520 (hereinafter referred to as '520 Reference) discloses an electronic information blackboard having a plurality of consoles (terminals) connected thereto. When pointer rods (arrow cursors) operable from a plurality of consoles are displayed simultaneously, it is difficult to recognize which is the pointer rod operated by the presenter and hence, it becomes difficult to accurately understand the intention of the presenter. In order to solve this problem, in the electronic information blackboard, one of the plurality of consoles is determined by a user operation to be a center console, and the center console determines limiting conditions and priority of other consoles. According to the description of '520 Reference, a user using a console sets shape and color of corresponding pointer rod. Further, '520 Reference describes that the pointer rod of a presenter who is permitted to operate the rod is flickered, displayed in a different color or different orientation than other pointer rods, or displayed in a larger size than other pointer rods.

Further, Japanese Patent Laying-Open No. 9-101767 (hereinafter referred to as '767 Reference) discloses a desk-top conference system in which a screen can be shared among a plurality of connected computers. In the desk-top conference system, when a material is shared on computer screens of conference participants and a pointer (tele-pointer) of another person is to be displayed on the screens, the name of the other person is shown near the corresponding tele-pointer. This makes it easier to recognize the position designated by other participants.

Further, Japanese Patent Laying-Open No. 2002-91642 (hereinafter referred to as '642 Reference) discloses a display apparatus displaying data input from a plurality of wireless input devices (wireless keyboards). In this display apparatus, input data (text) input from different wireless input devices are displayed in different manners of display (color, line thickness, line type and font). According to the description of '642 Reference, in connection with the cursor, the cursors corresponding to pointing device input units of wireless input devices are adapted to have different colors.

### DISCLOSURE OF THE INVENTION

### Problems to be Solved by the Invention

According to the technique disclosed in '520 Reference, it is possible to set only the cursor (pointer rod) of the presenter operable and to set the other cursors inoperable (stopped state). The plurality of cursors, however, are always kept in the displayed state, possibly causing a problem that information is hidden by the cursors and cannot be read. Further, switching between display/non-display of cursors requires a user operation, which is troublesome. These problems may occur even when only one cursor is displayed. The same applies to the techniques disclosed in '767 and '642 References.

Further, when a presenter wishes to emphasize certain specific information displayed on the screen, it is necessary for the presenter himself/herself to make some operation, for example, to move a computer mouse (hereinafter simply referred to as a mouse) and thereby to move a cursor, or to click a mouse button and drag the mouse, so as to make it easier to recognize the position of the information. Such operations are prone to error.

Therefore, an object of the present invention is to provide an image display apparatus and an image display system in which a cursor displayed on a screen can automatically be erased or re-displayed, and when a prescribed instruction is received, the cursor can be displayed in a special manner different from a usual manner.

### Means for Solving the Problems

According to a first aspect, the present invention provides an image display apparatus, including a display unit displaying an image and a communication unit communicating with an external device. The image display apparatus is provided with a control unit controlling the display unit. In response to the communication unit receiving data indicating that the external device is operated, the control unit causes the display unit to display a cursor corresponding to the external device. Determining that the external device is not operated for a prescribed time period, the control unit causes the display unit to erase the cursor corresponding to the external device.

Preferably, the image display apparatus further includes a timer for measuring, for every external device, from reception of the data indicating that the external device is operated, time passed without receiving the data indicating that the external device is operated, until the prescribed time period is elapsed. The control unit changes attribute of the cursor corresponding to the external device related to display by the display unit, in accordance with the passed time for every external device measured by the timer.

According to a second aspect, the present invention provides an image display apparatus, including a display unit displaying an image and a communication unit communicating with an external device. The image display apparatus is provided with a control unit controlling the display unit. In response to the communication unit receiving data indicating that the external device received a prescribed operation, the control unit changes attribute of the cursor corresponding to the external device related to display by the display unit.

Preferably, the external device has an input unit detecting a touched position. The prescribed operation is an operation of successively touching the input unit along a prescribed track.

More preferably, the prescribed operation is an operation of changing position or inclination of the external device.

According to a third aspect, the present invention provides an image display system including an image display apparatus and an external device capable of communicating with the image display apparatus. In the image display system, the external device includes a transmitting unit transmitting, to the image display unit, request data requesting display of a cursor. The image display apparatus includes a display unit displaying an image, a communication unit communicating with the external device, and a control unit controlling the display unit. When the external device is operated, the transmitting unit transmits operation data corresponding to the operation to the image display apparatus. In response to the communication unit receiving the operation data from the external device, the control unit causes the display unit to display a cursor corresponding to the external device. Determining that the external device is not operated for a prescribed time period, the control unit causes the display unit to erase the cursor corresponding to the external device.

### Effects of the Invention

According to the present invention, while a cursor displayed on the image display apparatus is operated by an external device for presentation in a conference or presentation, if the display of cursor is unnecessary, the cursor can automatically be erased. Further, while a cursor is being operated by a touch-operable external device and an operation unit (touch-panel or the like) is kept untouched for a while, display of the cursor can be maintained. Therefore, it is possible for the presenter to display or erase the cursor in an appropriate manner in accordance with his/her intention. Specifically, if the presenter thinks the cursor is unnecessary, what is only necessary for the presenter is intentionally leave the cursor unoperated for a prescribed time period. It is unnecessary to always pay attention to constantly touch the operation unit to have the cursor kept displayed.

Further, since the attribute of display of the cursor is changed until the cursor is erased, it is possible for the presenter to predict timing when the cursor will be erased. Therefore, he/she can easily know the timing to conduct an operation to keep the display. Thus, convenience of cursor operation is improved.

Further, by a prescribed operation to the external device, it is possible to display a cursor in a special manner different from the usual manner. Therefore, the presenter can easily convey his/her intention to others. The prescribed operation may be a touch operation of touching the touch operation unit of the external device along a prescribed track, an operation of shaking the external device itself, or an operation of tilting the external device. Thus, it is possible to display a cursor in a special manner by an instinctive operation.

### BRIEF DESCRIPTION OF DRAWINGS

FIG. 1 is a block diagram showing a configuration of an image display system in accordance with an embodiment of the present invention.

FIG. 2 is a block diagram schematically showing a configuration of the image display apparatus shown in FIG. 1.

FIG. 3 shows an example of a display screen of the image display apparatus shown in FIG. 1.

FIG. 4 is a block diagram schematically showing a configuration of a terminal shown in FIG. 1.

FIG. 5 shows an example of a display screen of the terminal shown in FIG. 1.

FIG. 6 is a flowchart representing a control structure of a program for operating a cursor displayed on a screen of the image display apparatus, executed in the terminal shown in FIG. 1.

FIG. 7 is a flowchart representing a control structure of a program for controlling the manner of displaying a cursor displayed on the screen, executed in the image display apparatus shown in FIG. 1.

FIG. 8 is a flowchart representing a control structure of a program of a cursor erasing process shown in FIG. 7.

FIG. 9 shows a data structure to be transmitted from the terminal to the image display apparatus.

FIG. 10 shows a data structure related to a cursor, stored in the image display apparatus.

FIG. 11 shows an example of a screen image on a terminal, different from FIG. 5.

FIG. 12 is a flowchart, different from FIG. 8, representing a control structure of a program of a cursor erasing process.

FIG. 13 is a flowchart, different from FIG. 6, representing a control structure of a program for operating a cursor displayed on a screen of the image display apparatus executed in the terminal shown in FIG. 1.

FIG. 14 is a flowchart, different from FIG. 7, representing a control structure of a program for controlling the manner of displaying a cursor displayed on the screen, executed in the image display apparatus shown in FIG. 1.

FIG. 15 is a block diagram showing a configuration of an image display system different from FIG. 1.

### DESCRIPTION OF EMBODIMENTS

In the following embodiments, the same components are denoted by the same reference characters. Their names and functions are also the same. Therefore, detailed description thereof will not be repeated.

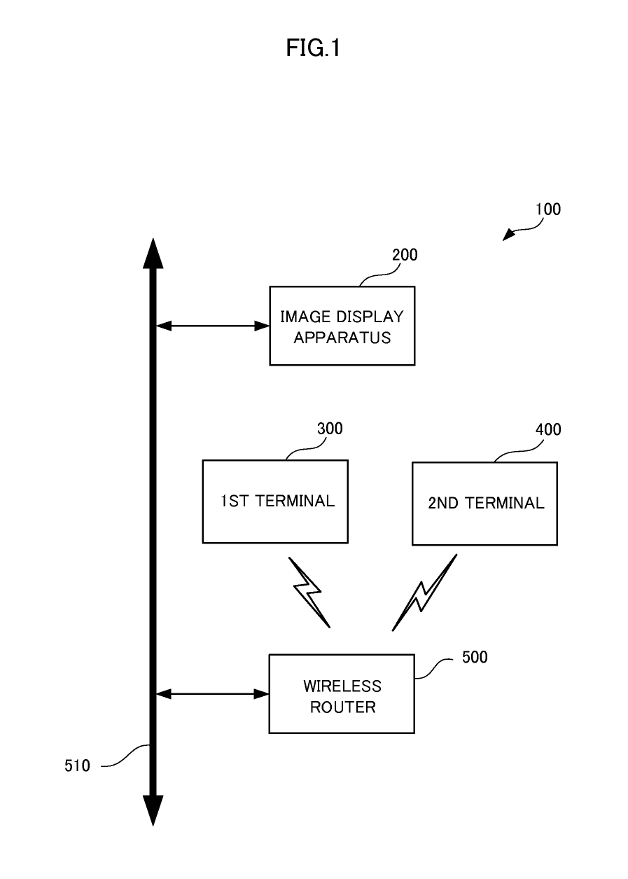

Referring to FIG. 1, an image display system 100 in accordance with the present embodiment includes an image display apparatus 200, a first terminal 300, a second terminal 400 and a wireless router 500. Image display apparatus 200 and wireless router 500 are wire-connected to a communication network (including LAN and the Internet, hereinafter simply referred to as a network) 510. Image display apparatus 200 is, for example, a large-screen, touch-drawing electronic blackboard apparatus. The first and second terminals 300 and 400 are portable terminals. The first and second terminals 300 and 400 are, for example, a tablet device having a display screen of about 10 inches, or a smart phone having a display screen of a smaller size (a few inches) than the tablet device.

Wireless router 500 is a device for connecting equipment capable of wireless communication in accordance with a prescribed communication protocol such as TCP/IP, to network 510. The first and second terminals 300 and 400 can be connected to network 510 through wireless router 500. Though not shown in FIG. 1, there may be other terminals capable of wireless communication around image display system 100, in addition to the first and second terminals 300 and 400.

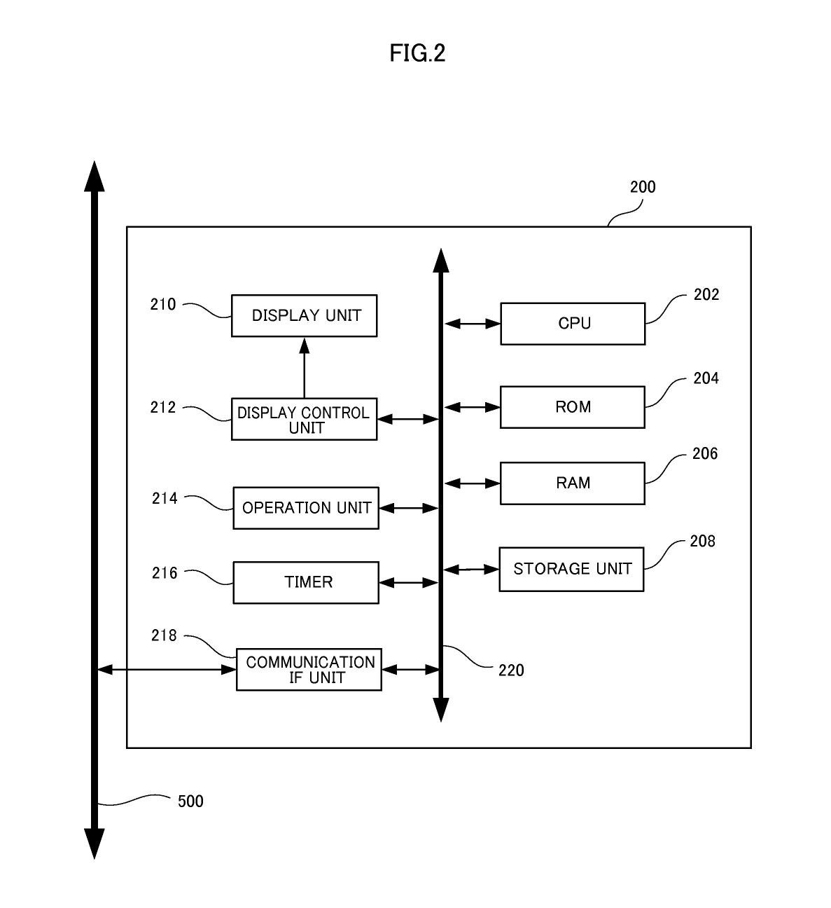

Referring to FIG. 2, image display apparatus 200 includes a control unit (hereinafter referred to as a CPU) 202 for overall control of image display apparatus 200; an ROM (Read Only Memory) 204 for storing programs and the like; an RAM (Random Access Memory) 206 as a volatile storage device; a storage unit 208, and a bus 220. ROM 204 stores programs and data necessary for controlling operations of image display apparatus 200. Storage unit 208 is a non-volatile storage device that retains data even when electric power is turned off, and it is, for example, a hard disk drive or a flash memory. Storage unit 208 may be configured as a detachable unit having a prescribed interface (USB or the like).

CPU 202, ROM 204, RAM 206 and storage unit 208 are connected to bus 220. Data (including control information) is exchanged among these components through bus 220. CPU 202 reads a program from ROM 204 through bus 220 to RAM 206 and executes the program using a part of RAM 206 as a work area. Specifically, CPU 202 controls various components and units forming image display apparatus 200 and realizes each of the functions of image display apparatus 200 in accordance with a program or programs stored in ROM 204.

RAM 206 has a function of a video memory for displaying an image. Specifically, a part of RAM 206 is used as a VRAM (Video Random Access Memory). In the following, that area of RAM 206 which is used as the VRAM will be referred to as the VRAM area. A configuration having a VRAM separate from RAM 206 is also possible.

Image display apparatus 200 further includes a display unit 210, a display control unit 212, an operation unit 214, a timer 216, and a communication IF unit 218. Display control unit 212, operation unit 214, timer 216 and communication IF unit 218 are connected to bus 220. Here, description will be given assuming that image display apparatus 200 is an electronic blackboard.

Display unit 210 is a display panel (liquid crystal panel or the like) for displaying an image. Display control unit 212 has a driving unit for driving display unit 210, and it reads image data stored in the VRAM area of RAM 206 at prescribed timing, generates a signal for displaying the data as an image on display unit 210 and outputs the signal to display unit 210. The image data to be displayed is read by CPU 202 from storage unit 208 and transferred to RAM 206. In this manner, the data stored in the VRAM area is displayed as an image on display unit 210.

Timer 216 receives a request from CPU 202 and transfers information representing current time (hereinafter also simply referred to as current time) to CPU 202.

Communication IF unit 218 is, for example, an NIC (Network Interface Card), which is connected by a communication cable to a hub (not shown) or the like, and through the hub or the like, connected to network 510. Thus, image data can be transmitted to/received from a terminal (computer or the like) connected to network 510. The image data received from outside through communication IF unit 218 is stored in storage unit 208.

Operation unit 214 receives an input such as an instruction to image display apparatus 200 by a user. In the electronic blackboard apparatus, operation unit 214 is arranged on a display unit 210 implemented, for example, by a liquid crystal panel, and it includes a touch detecting device having LEDs and the like for detecting a touched position, and an operation key portion (both not shown). In order to operate image display apparatus 200, software keys (hereinafter also referred to as soft keys) are displayed on display unit 210, and hardware keys (hereinafter also referred to as hard keys) are arranged on the operation key portion. CPU 202 monitors user operations on these keys. The user can input an instruction of a process on the displayed contents to image display apparatus 200, by touching these keys. Selection of the soft keys displayed on display unit 210 is realized by detecting a touched position, by a touch detecting device.

The touch detecting device is, for example, a known infrared scanning type touch-panel. The touch-panel has arrays of light emitting diodes (hereinafter denoted as LED arrays) arranged in a line on adjacent two sides of a rectangular writing surface, respectively, and two arrays of photodiodes (hereinafter referred to as PD arrays) arranged in a line opposite to the LED arrays, respectively. Infrared rays are emitted from each LED of LED arrays, and the infrared rays are detected by each PD of opposite PD arrays.

When a user touches a point on the touch-panel with a touch pen, the infrared ray is intercepted by the tip of touch pen. The touched position can be detected in the similar manner when the user touches touch detecting device with his/her finger, without using the touch pen that enables calculation of the touched positional coordinates.

The technique for detecting the touched position described above is well known and, therefore, further description will not be given here. A touch-panel other than the infrared scanning type panel (such as a capacitive type, surface acoustic wave type or resistive type touch-panel) may be used as the touch detecting device.

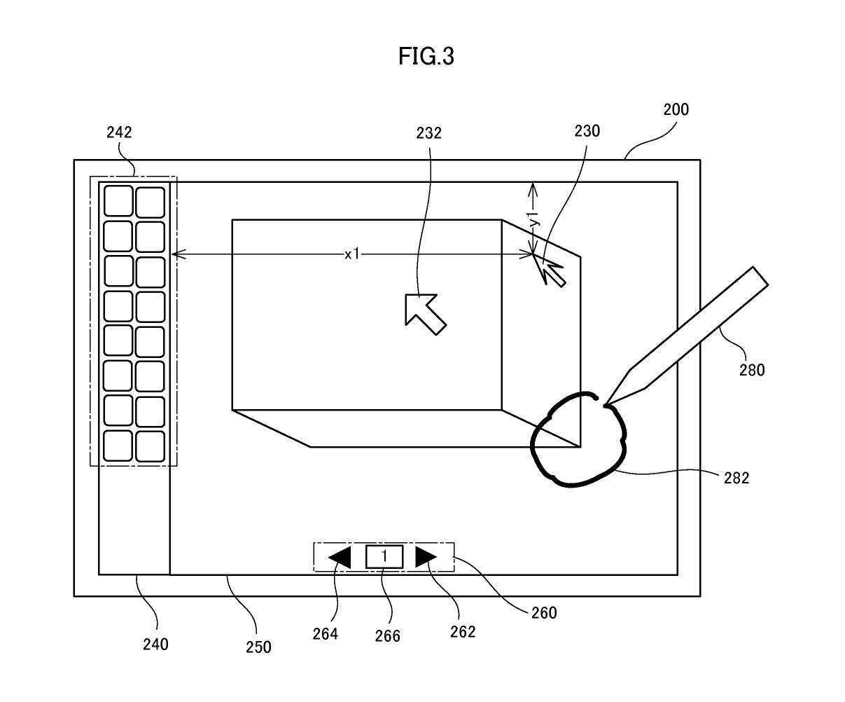

On image display apparatus 200, a screen image such as shown in FIG. 3 is displayed. The display screen image of display unit 210 is divided to a drawing area 250 and a function button area 240. Drawing area 250 is for the user to draw an image by touching operations. Specifically, XY coordinates of touched position and track of its movement are transmitted from touch detecting device to CPU 202 as described above. In accordance with the received coordinate data, CPU 202 writes a prescribed value in a corresponding memory address on RAM 206. While pixel values of image data on the VRAM area of RAM 206 may be changed, here, it is assumed that RAM 206 is provided with an area (hereinafter also referred to as an overlay area) for storing drawing data, separate from the VRAM area for storing image data. Assuming that data of a memory address where drawing is not done of the overlay area is “0,” CPU 202 writes “1” to a memory address that corresponds to the drawn position. Display control unit 212 superimposes and displays on display unit 210 the image data (the data in the VRAM area) with the drawing data (the data in the overlay area). Specifically, on a point where the drawing data exists (the pixel having “1” recorded in the overlay area), the drawing data is displayed (preset color is displayed), and on a point where the drawing data does not exist (the pixel having “0” recorded in the overlay area), the image data is displayed. In FIG. 3, on an image displayed on drawing area 250, a FIG. 282 drawn by a touch pen 280 is displayed.

On function button area 240, function buttons each having a specific function allocated thereto are displayed (see an area 242 surrounded by chain-dotted line). Functions allocated to the function buttons may include: a function of drawing by a touch operation; an erasure function of deleting a drawing in a prescribed area; a function of opening a file (image data) saved in storage unit 208; a function of saving displayed image data in storage unit 208; and a function of printing displayed image data. Each function button is displayed as an icon. Each function button includes an icon instructing execution of an image processing on the displayed image.

At a lower portion of drawing area 250, a page operation area 260 is displayed. On this area, a NEXT button 262, a PREVIOUS button 264 and a page number indication box 266 are displayed. When touched, NEXT button 262 feeds the displayed page (image displayed in drawing area 250) to the right and shows the next page. When touched, PREVIOUS button 264 feeds the displayed page to the left and shows the previous page. Page number indication box indicates the page number of the currently displayed page, of the plurality of pages as the object of display. The position of page operation area 260 is fixed and it does not move even during scrolling. By way of example, the data for displaying page operation area 260 on display unit 210 may be stored in an overlay area separate from the overlay area for drawing.

When the user touches NEXT button 262, coordinate data of the touched position is transmitted from the touch detecting device to CPU 202. CPU 202 determines that the received coordinate data represents a position in the area where NEXT button 262 is displayed. Assuming that a series of image data as the object of display is all read from storage unit 208 and stored in RAM 206 in advance, display control unit 212 generates image data (image data corresponding to 1 page) in the course of page feed from the image data corresponding to the currently displayed page and the image data corresponding to the next page on RAM 206 and overwrites the VRAM area. Consequently, an image in the course of page feed appears on display unit 210.

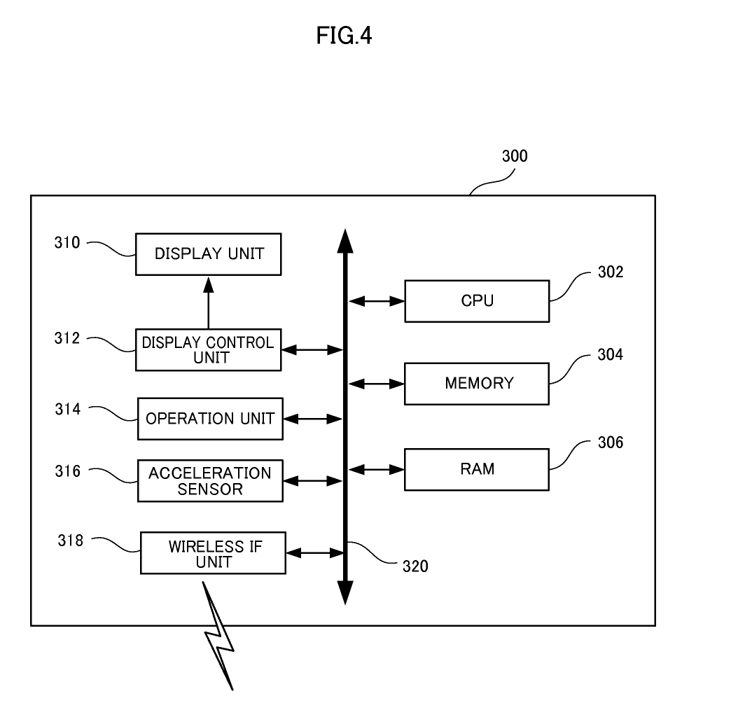

Referring to FIG. 4, the first terminal 300 includes a CPU 302 for overall control of first terminal 300, a memory 304, an RAM 306, and a bus 320. Memory 304 is an electrically rewritable non-volatile storage device, such as a flash memory. Memory 304 stores programs and data necessary for controlling operations of the first terminal 300.

CPU 302, memory 304 and RAM 306 are connected to bus 320. Data (including control information) is exchanged among these components through bus 320. CPU 302 reads a program from memory 304 through bus 320 to RAM 306 and executes the program using a part of RAM 306 as a work area. Specifically, CPU 302 controls various components and units forming the first terminal 300 and realizes each of the functions of the first terminal 300 in accordance with a program or programs stored in memory 304.

RAM 306 has a function of a video memory for displaying an image. Specifically, a part of RAM 306 is used as a VRAM. A configuration having a VRAM separate from RAM 306 is also possible.

The first terminal 300 further includes a display unit 310, a display control unit 312, an operation unit 314, a wireless IF unit 318 and an acceleration sensor 316. Display control unit 312, operation unit 314, wireless IF unit 318 and acceleration sensor 316 are connected to bus 320. Here, description will be given assuming that the first terminal 300 is a tablet device.

Display unit 310 is a display panel (liquid crystal panel or the like) for displaying an image. Display control unit 312 has a driving unit for driving display unit 310, and it reads image data stored in RAM 306 at prescribed timing, generates a signal for displaying the data as an image on display unit 310 and outputs the signal to display unit 310. The image data to be displayed is read by CPU 302 from memory 304 and transferred to RAM 306. Wireless IF unit 318 communicates with wireless router 500 in a wireless manner, and enables connection of the first terminal 300 to network 510.

Operation unit 314 receives an input such as an instruction to the first terminal 300 by a user. In the tablet device, operation unit 314 is arranged on a display unit 310 implemented, for example, by a liquid crystal panel, and it includes a touch-panel for detecting a touched position, and an operation key portion (neither being shown). In order to operate the first terminal 300, soft keys are displayed on display unit 310, and hard keys are arranged on the operation key portion. CPU 302 monitors user operations on these keys. The user can input an instruction to the first terminal 300 by touching these keys. Selection of the soft keys displayed on the display panel is realized by detecting a touched position, by the touch-panel.

The touch-panel is, by way of example, a known sheet type touch-panel. Since the method of detecting a touched position is known, description thereof will not be repeated here.

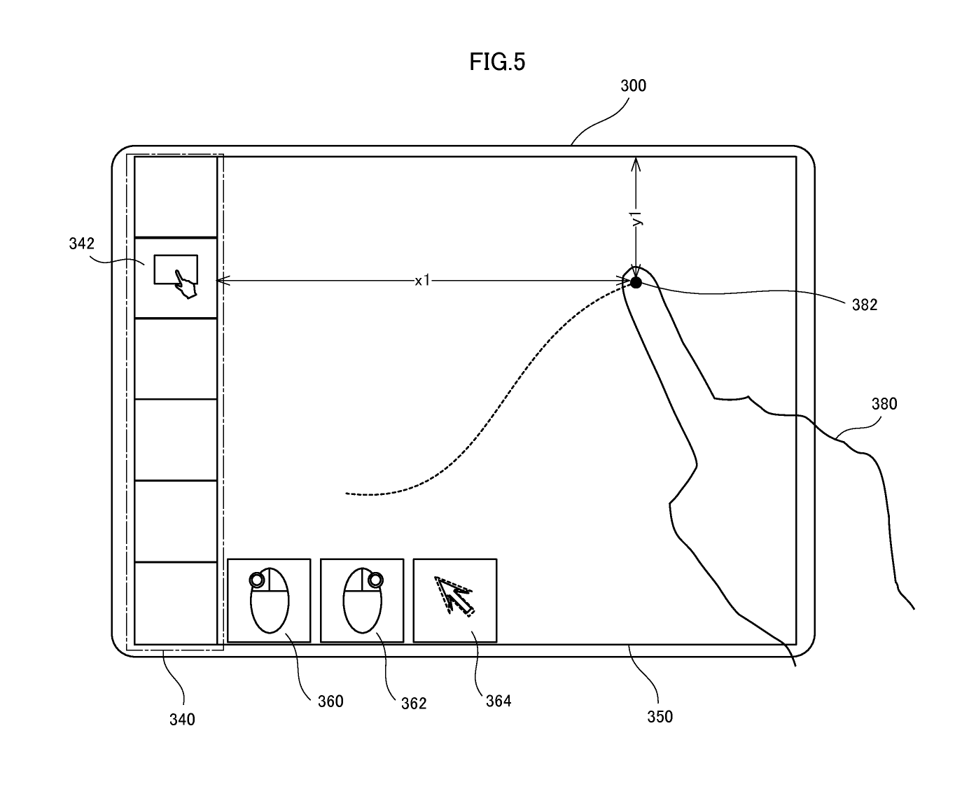

On the first terminal 300, an image such as shown in FIG. 5 is displayed. The display screen of display unit 310 is divided to an input area 350 and a function button area 340. On function button area 340, function buttons each having specific function allocated thereto are displayed.

Input area 350 is for the user to input the touched position. Specifically, XY coordinates of touched position and track of its movement are detected by the touch-panel and transferred to CPU 302. FIG. 5 shows a track of a finger of a user 380 (only the contour of his/her hand is shown), kept touching and moved on input area 350, represented by a dotted line. A point 382 represents the point currently touched by the finger, of which position coordinates are (x1, y1). The upper left vertex of input area 350 is the origin, the right direction is the positive direction of X axis and the downward direction is the positive direction of Y axis. CPU 302 analyzes the positional coordinates detected by the touch-panel in consideration of timings of their occurrence/disappearance, whereby it can detect gestures such as a tap (a light and rapid touch), a double-tap (taps repeated twice consecutively), and a flick (moving or snapping one's finger while touching the screen). Operation icons may be displayed on input area 350. Three icons 360 to 364 shown in FIG. 5 will be described later.

Acceleration sensor 316 detects an acceleration vector generated by an external force exerted on the first terminal 300. The external force includes gravity. Data output from acceleration sensor 316 is analyzed by CPU 302 and, by way of example, attitude (orientation with respect to the gravity) of the first terminal 300 is determined.

The second terminal 400 has the same configuration and functions as the first terminal 300 and, therefore, accumulative description will not be repeated.

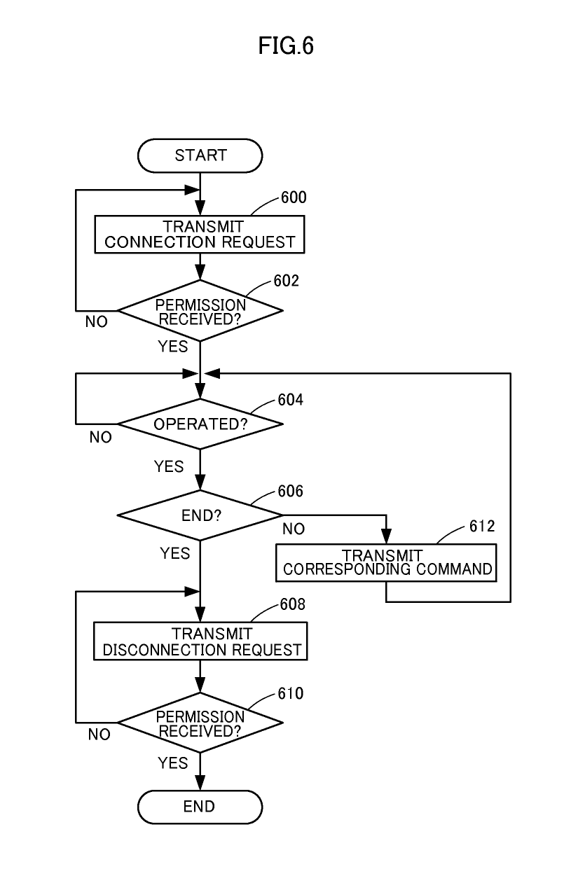

The following will give a description of a control structure of a program for controlling the manner of display of a cursor displayed on a screen of image display apparatus 200 in image display system 100 shown in FIG. 1 with reference to FIGS. 6 to 8. Control of the manner of displaying the cursor is realized by transmission/reception of prescribed data between the first or second terminal 300 or 400 and image display apparatus 200.

In the following, it is assumed that image display apparatus 200 is an electronic blackboard apparatus installed at a place for presentation or conference, and the first and second terminals 300 and 400 are tablets used by participating users. The program of image display apparatus 200 is automatically executed when the power is turned on and the apparatus is ready to execute normal functions such as image display and network communication. In the first and second terminals 300 and 400, the program is activated by a user operation. Communication between the first and second terminals 300 and 400 and image display apparatus 200 is in accordance with a known communication protocol such as TCP/IP, and it is assumed that IP address of image display apparatus 200 is stored in the first and second terminals 300 and 400.

Here, assume that the user operates the first terminal 300 and a function button 342 (see FIG. 5) is tapped. When function button 342 is tapped, an application program (hereinafter also referred to as an application) for displaying a cursor on image display apparatus 200 is activated. Here, function button 342 assumes an appearance indicating a selected state (for example, highlighted state).

At step 600, CPU 302 transmits data for requesting connection (hereinafter referred to as connection request command) through wireless IF unit 318 to image display apparatus 200. Specifically, CPU 302 reads the IP address of image display apparatus 200 from memory 304, and transmits prescribed data including the connection request command to the read IP address. The data transmitted here includes IP address of first terminal 300 as the source of transmission.

At step 602, CPU 302 determines, for a prescribed time period, whether data permitting connection (hereinafter also referred to as connection permission code) is received. If it is determined that the data is received, the control proceeds to step 604.

If it is not received within the prescribed time period, the control returns to step 600. As will be described later, when the connection request command transmitted at step 600 is received by image display apparatus 200, prescribed data including the connection permission data is transmitted from image display apparatus 200 to the IP address of first terminal 300 as the source of transmission. The data includes a terminal ID. A plurality of terminals including the first and second terminals 300 and 400 can be connected to image display apparatus 200, and hence, the terminal ID is an ID uniquely allocated by image display apparatus 200 to distinguish the plurality of terminals.

At step 604, CPU 302 determines whether or not any operation has been done by the user. If it is determined that any operation has been done, the control proceeds to step 606. Otherwise, step 604 is repeated. Operations may include an operation on the touch-panel, such as touch and drag operations of input area 350, a tap operation of displayed icons (such as icons 360 to 364 shown in FIG. 5) as well as an operation of the first terminal 300 as a whole. Specifically, the operation of the first terminal 300 as a whole includes an operation of changing the attitude of first terminal 300, or an operation of shaking the first terminal 300. CPU 302 determines the operation of the first terminal 300 as a whole using the acceleration detected by acceleration sensor 316. Further, the operation includes an operation of cancelling a designated operation (for example, an operation of cancelling a special display of a cursor).

At step 606, CPU 302 determines whether or not the operation detected at step 604 is an instruction to end the present application that is being executed. An end instruction is made by tapping function button 342 that is in the selected state. If it is an end instruction, the control proceeds to step 608. Otherwise, the control proceeds to step 612.

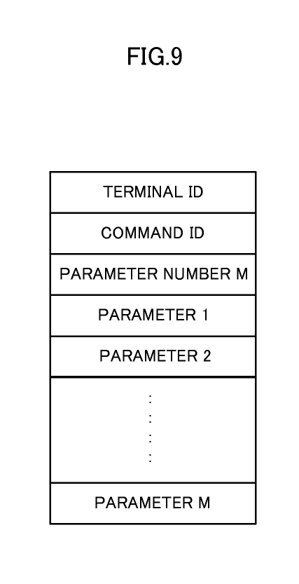

At step 612, CPU 302 transmits data including a command in accordance with the operation to image display apparatus 200. By way of example, the data transmitted here has such a structure as shown in FIG. 9. In FIG. 9, data in each box represents data of a prescribed number of bits. The terminal ID represents the data received at step 602 (the ID allocated by image display apparatus 200 to the first terminal 300). The command ID is an ID determined in advance corresponding to the operation. The parameter number M represents the total number of parameters contained, and parameters 1 to M represent values of respective parameters.

By way of example, when the user touches input area 350 with his/her finger, a command ID instructing display, and X and Y coordinates as parameters representing the touched point are transmitted. When the user drags, steps 604, 606 and 612 are repeated and these data are transmitted repeatedly.

When icon 360 is tapped, a command ID corresponding to a left click of a mouse is transmitted. When icon 362 is tapped, a command ID corresponding to a right click of a mouse is transmitted. When icon 364 is tapped, a command ID instructing flickering display of a cursor is transmitted. The command ID instructing flickering display of a cursor may be transmitted when it is detected that the input area 350 is kept touched and the touched position is moved to draw a prescribed track (such as a check-mark figure). Alternatively, when an operation of changing the attitude of first terminal 300 or an operation of shaking the first terminal 300 is detected, the command ID instructing flickering display of a cursor may be transmitted.

At step 608, CPU 302 transmits data requesting disconnection (hereinafter also referred to as disconnection request command) to image display apparatus 200. Here, the disconnection request command is transmitted with the data structure shown in FIG. 9. Namely, the terminal ID is also transmitted.

At step 610, CPU 302 determines, for a prescribed time period, whether or not data permitting disconnection (hereinafter also referred to as disconnection permission code) is received. If it is determined that the data is received, the present program ends. If it is not received in the prescribed time period, the control returns to step 608. As will be described later, when the disconnection request command transmitted at step 610 is received by image display apparatus 200, the disconnection permission command is transmitted from image display apparatus 200 to the IP address of first terminal 300 as the source of transmission.

In this manner, when the user activates the application, the first terminal 300 requests connection to image display apparatus 200, and when the connection is permitted and thereafter the user operates the first terminal 300, data for moving the cursor displayed on image display apparatus 200, data for flickering the cursor and the like can be transmitted to image display apparatus 200. By processing the received data, image display apparatus 200 changes the manner of display of the cursor, as will be described in the following.

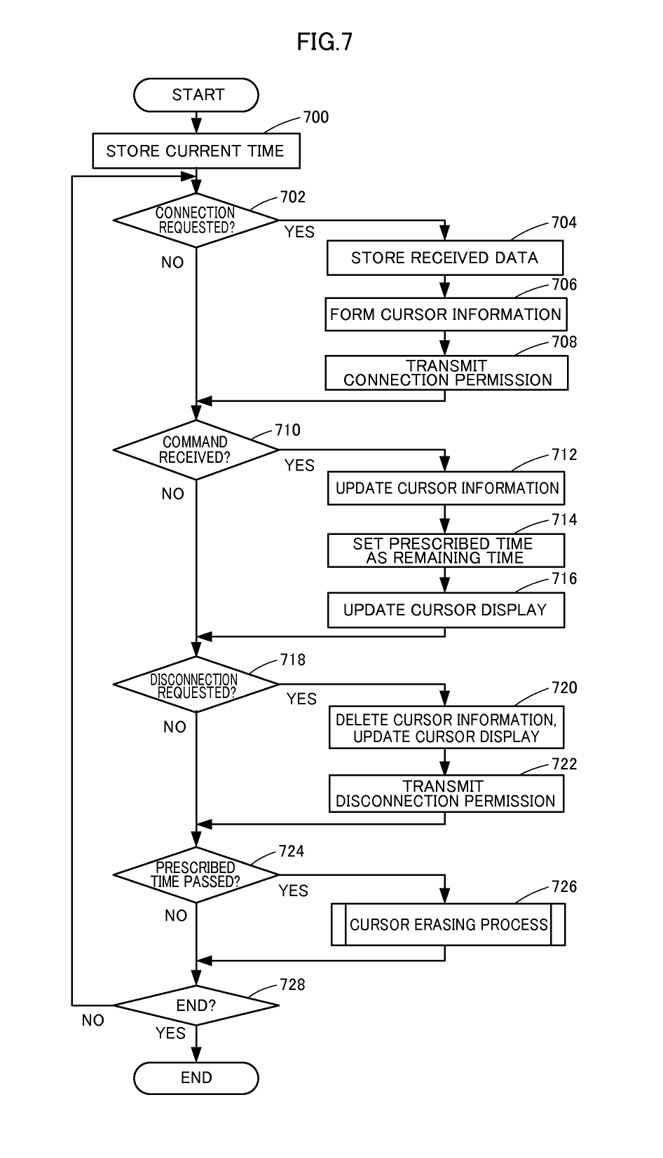

Referring to FIG. 7, at step 700, CPU 202 obtains the current time (time information) from timer 216, and stores it as a start time in RAM 206.

At step 702, CPU 202 determines whether or not the connection request command is received. If it is determined that the command is received, the control proceeds to step 704. Otherwise, the control proceeds to step 710.

At step 704, CPU 202 stores the IP address of transmission source of the received data in RAM 206. Here, CPU 202 determines a unique terminal ID, and stores it in association with the IP address, in RAM 206.

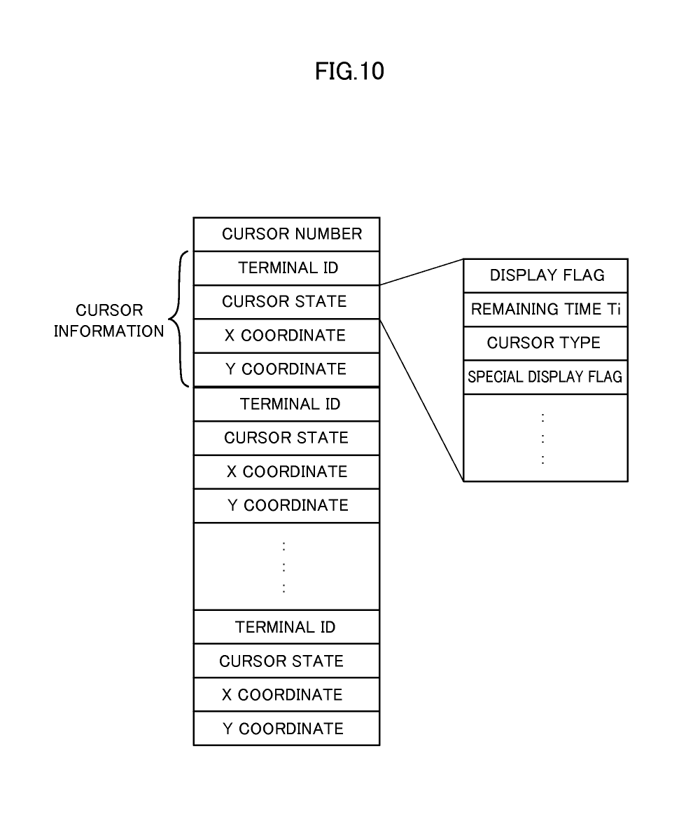

At step 706, CPU 202 forms cursor information and stores it in RAM 206. The cursor information is stored, by way of example, with the data structure shown in FIG. 10. In FIG. 10, the cursor number represents the total number of cursors managed by CPU 202. The “cursor number” here is not always the same as the total number of cursors displayed on display unit 210, as will be described later. The total number of cursors displayed on display unit 210 is equal to or smaller than the “total number of cursors.” The terminal ID, cursor state, and X and Y coordinates are stored as a set, and the set is referred to as the cursor information. The terminal ID is the ID uniquely determined at step 704. The X and Y coordinates represent the current positional coordinates of the cursor corresponding to the terminal ID. When the cursor information is newly formed, the X and Y coordinates are set to values representing a prescribed position (for example, origin or a central position of the drawing area).

The cursor state further includes a display flag, a remaining time Ti, data specifying cursor type, and a special display flag. The display flag indicates whether or not the corresponding cursor is to be displayed on display unit 210. By way of example, if the flag is “1,” the cursor is displayed, and if it is “0,” it is not displayed. When the cursor information is newly formed, the display flag is set to “0.” The remaining time Ti represents the time until the cursor displayed on display unit 210 is erased.

The cursor type represents data for specifying the appearance (shape and color) of the cursor displayed on display unit 210. In the storage unit of image display apparatus 200, image data of a plurality of different types of cursors are stored, and the cursor type is uniquely allocated to each image data. When cursor information corresponding to the determined terminal ID is to be newly formed, CPU 202 allocates a cursor type different from already used cursor type or types, so that a user can easily distinguish the cursors simultaneously displayed on display unit 210 from each other.

The special display flag represents data indicating whether or not the cursor is to be displayed in a manner different from the normal. Here, “0” means the normal manner of display and “1” means the special display. When the cursor information is newly formed, the special display flag is set to “0.”

The cursor information shown in FIG. 10 is looked up when the screen image to be displayed on display unit 210 is generated. At this stage where the cursor information is newly generated, the display flag is “0” as described above and, therefore, the corresponding cursor is not displayed on display unit 210.

At step 708, CPU 202 transmits prescribed data including the connection permission code, to the terminal that has transmitted the connection request code. The data transmitted here includes the terminal ID determined at step 704.

At step 710, CPU 202 determines whether or not the data including a command ID related to a cursor operation has been received. If it is determined that the data has been received, the control proceeds to step 712. Otherwise, the control proceeds to step 718. The command ID related to the cursor operation is the command ID, corresponding to the operation of the terminal, transmitted from the terminal of which connection is permitted (the terminal to which the connection permission code is sent at step 708), as described above. The data received here (the data transmitted from the terminal at step 612) includes the terminal ID, as described above.

At step 712, CPU 202 updates the cursor information in accordance with the data received at step 710. Image display apparatus 200 stores a plurality of pieces of cursor information as shown in FIG. 10. The cursor information to be updated is specified by the terminal ID included in the data received at step 710. CPU 202 sets the corresponding display flag to “1,” and if the received data contains X and Y coordinates, writes these values to the X and Y coordinates of the corresponding cursor information. Further, if the received command ID is the ID instructing special display, the special display flag is set to “1.” If the received command ID is the ID instructing cancellation of special display, the special display flag is set to “0.”

At step 714, CPU 202 writes a prescribed value Ts as the initial value, to remaining time Ti. The initial value Ts written here is, for example, 10 seconds.

At step 716, CPU 202 looks up the cursor information (see FIG. 10) and updates display of all cursors it manages. Specifically, CPU 202 writes image data including the cursor images at updated positions, in the VRAM area of RAM 206. By way of example, when the connection request command is received from the first terminal 300, a cursor 230 is displayed, as shown in FIG. 3. The positional coordinates (x1, y1) of cursor 230 correspond to the X and Y coordinates received from the first terminal 300, that is, the coordinates (x1, y1) of the touched position shown in FIG. 5. Further, CPU 202 flickers the display of cursor specified by the cursor type corresponding to the special display flag set to “1.” For flickering, by way of example, two types of cursor image data having the same design and different luminance may be stored in advance, and the image data of these may be written to prescribed position of the VRAM area alternately at a prescribed time interval.

At step 718, CPU 202 determines whether data containing the disconnection request command is received. The data containing the disconnection request command and the terminal ID is transmitted from that terminal to which CPU 202 has transmitted the connection permission code at step 708 (see step 608). If it is determined that the data is received, the control proceeds to step 720. Otherwise, the control proceeds to step 724.

At step 720, CPU 202 removes cursor information including the terminal ID contained in the received data and updates the cursor display. Thus, the cursor that has been displayed by that time is erased from display unit 210.

At step 722, CPU 202 transmits the disconnection permission code to the terminal that has transmitted the disconnection request command.

At step 724, CPU 202 determines whether or not a prescribed time period has passed. Specifically, CPU 202 obtains the current time from timer 216, and determines whether the prescribed time period has passed from the start time (time information) stored in RAM 206. The prescribed time period is, for example, 1 second. If it is determined that the prescribed time has passed, CPU 202 overwrites the start time in RAM 206 by the obtained current time, and then the control proceeds to step 726. Otherwise, the control proceeds to step 728.

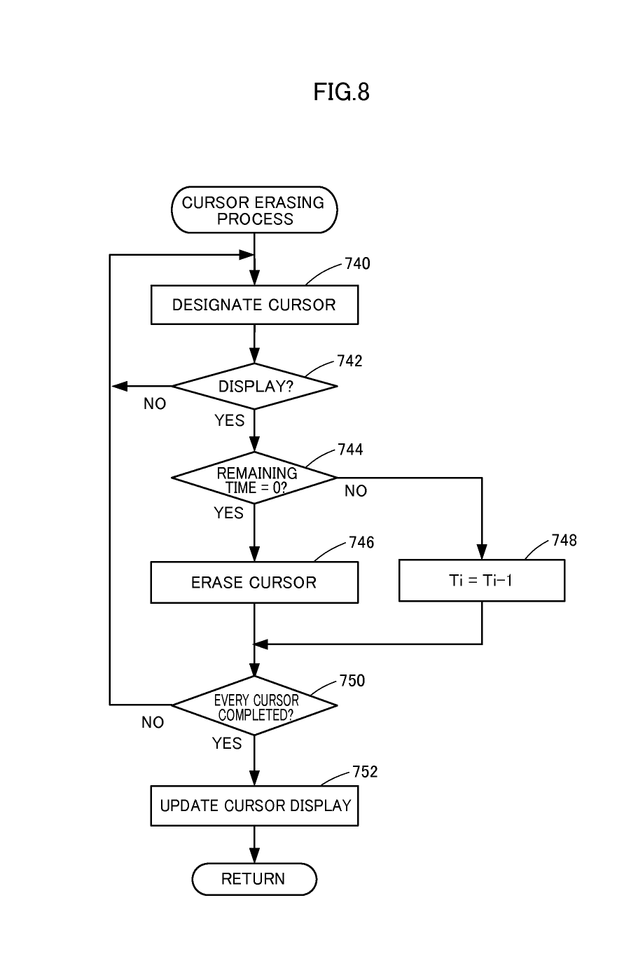

At step 726, CPU 202 executes a cursor erasing process. The cursor erasing process is for erasing a cursor that has not been operated for a prescribed time period. It is noted, however, that the cursor information is kept stored in RAM 206, and the cursor that is not displayed is also an object of control by CPU 202. The cursor erasing process will be described later with reference to FIG. 8.

At step 728, CPU 202 determines whether an end instruction is received. The end instruction is, for example, an instruction to turn off the power of image display apparatus 200. If it is determined that the end instruction is received, the program ends. Otherwise, the control proceeds to step 702.

Referring to FIG. 8, at step 740 of the cursor erasing process, CPU 202 designates one cursor among the cursors it manages. Specifically, CPU 202 designates a terminal ID included in the pieces of cursor information stored in RAM 206.

At step 742, CPU 202 determines whether or not the cursor designated at step 740 is being displayed. Specifically, CPU 202 determines whether the value of display flag corresponding to the terminal ID designated at step 740 is “1” or not. If it is determined that the cursor is being displayed, the control proceeds to step 744. Otherwise (if the cursor is not displayed), the control returns to step 740, and a cursor, which will not overlap, is designated at step 740.

At step 744, CPU 202 determines whether the time period for maintaining the display of the cursor designated at step 740 is “0.” Specifically, CPU 202 determines whether or not the remaining time period Ti corresponding to the terminal ID designated at step 740 is “0.” If it is determined to be “0,” the control proceeds to step 746. Otherwise, the control proceeds to step 748.

At step 746, CPU 202 sets the cursor designated at steps 740 to be erased. Specifically, CPU 202 sets the display flag corresponding to the terminal ID designated at step 740 to “0.”

At step 748, CPU 202 decreases one from the remaining time period Ti, and overwrites the remaining time period Ti in RAM 206 with the resulting value as the new remaining time period.

At step 750, CPU 202 determines whether or not the process has been completed on every cursor as the object of management. If it is determined that the process is completed on every cursor, the control proceeds to step 752. Otherwise (if any cursor is left unprocessed), the control returns to step 740, and a cursor, which will not overlap, is designated at step 740.

At step 752, CPU 202 looks up the cursor information (see FIG. 10) as at step 716, and updates displays of all cursors it manages. Thereafter, the control returns to step 728 (see FIG. 7).

As described above, until the end instruction is received, the processes of steps 700 to 726 and 740 to 752 are repeated in image display apparatus 200. Thus, if a connection request is received from a terminal, image display apparatus 200 generates cursor information for managing the cursor to be displayed on display unit 210, and stores it in RAM 206 (steps 702 to 708). Thereafter, in accordance with the data received from the terminal of which connection has been permitted, CPU 202 changes the manner of display of the corresponding cursor (steps 710 to 716).

Further, it is possible for image display apparatus 200 to periodically erase (for example, at every one second) a cursor if image display apparatus 200 has not received data for operating the cursor for a prescribed time period (for example, ten seconds) (steps 740 to 752). If the user operates the terminal and image display apparatus 200 receives data for operating the cursor, image display apparatus 200 can re-display the corresponding cursor (steps 712 and 714). Specifically, image display apparatus 200 can display only the cursors that are necessary for the user, and it can temporarily erase the unnecessary cursor or cursors. Therefore, the situation can be avoided in which unoperated cursor or cursors are left lingering on the screen hiding information to be read.

When a disconnection request is received from a terminal, image display apparatus 200 deletes the corresponding cursor information from RAM 206 and removes it from the objects of management, and the cursor is erased (steps 718 to 722).

In the foregoing, an example has been described in which the first terminal 300 has the corresponding cursor displayed on image display apparatus 200 to be operated. It is also possible, however, that another terminal, such as the second terminal 400, to issue a connection request to image display apparatus 200 and has its corresponding cursor displayed thereon. Image display apparatus 200 allocates terminal IDs not overlapping with each other to terminals that have transmitted the connection request commands to image display apparatus 200 and, therefore, it is possible for image display apparatus 200 to independently manage (display, display in a special manner or erase) each of the plurality of cursors. By way of example, in FIG. 3, in addition to cursor 230 corresponding to the first terminal 300, a cursor 232 is displayed. Cursor 232 is, for example, a cursor corresponding to the second terminal 400, and it has a shape different from cursor 230.

In the foregoing, though an example in which the special display is flickering of the cursor has been described, it is not limiting. When the special display is set, the cursor may be displayed in a color different from the normal display, or a cursor having a shape different from the normal display may be displayed. Here, the color or the shape, or the color and the shape may be changed and displayed in a short period by utilizing animation.

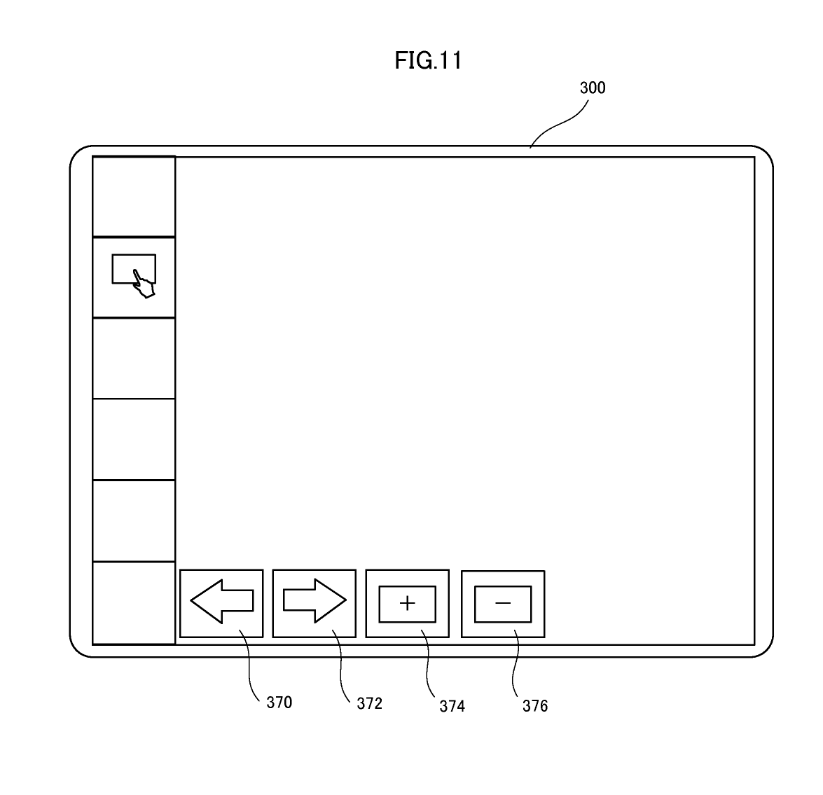

In the foregoing, though an example has been described in which icons 360 to 364 shown in FIG. 5 are displayed on the first terminal 300, it is not limiting. By way of example, icons 370 to 376 shown in FIG. 11 may be displayed. When icon 370 is tapped, CPU 302 transmits data (data containing corresponding command ID) instructing feed of the page displayed on image display apparatus 200 to the left and display of the previous page. When icon 372 is tapped, CPU 302 transmits data (data containing corresponding command ID) instructing feed of the paged displayed on image display apparatus 200 to the right and display of the next page. When icon 374 is tapped, CPU 302 transmits data (data containing corresponding command ID) instructing enlarged display of the page that is displayed on image display apparatus 200. When icon 376 is tapped, CPU 302 transmits data (containing corresponding command ID) instructing reduced display of the page that is displayed on image display apparatus 200. Icons instructing image display apparatus 200 to execute other operations may be displayed on the first terminal 300.

The configuration of cursor information is not limited to the above. The information may include data other than those described above, or it may not include the data described above. By way of example, if the cursor information includes the remaining time Ti, it may not include the display flag. In that case, the remaining time Ti may be adapted to have the function of display flag. Specifically, operation may be controlled such that if the remaining time has a value other than “0,” the cursor is displayed, and if the remaining time is “0,” the cursor is not displayed. Further, the IP address of terminal may be used as the terminal ID. Further, if network 510 is an intranet, not the entire bit data but the host address (portion other than the fixed network address) of the IP address may be used as the terminal ID.

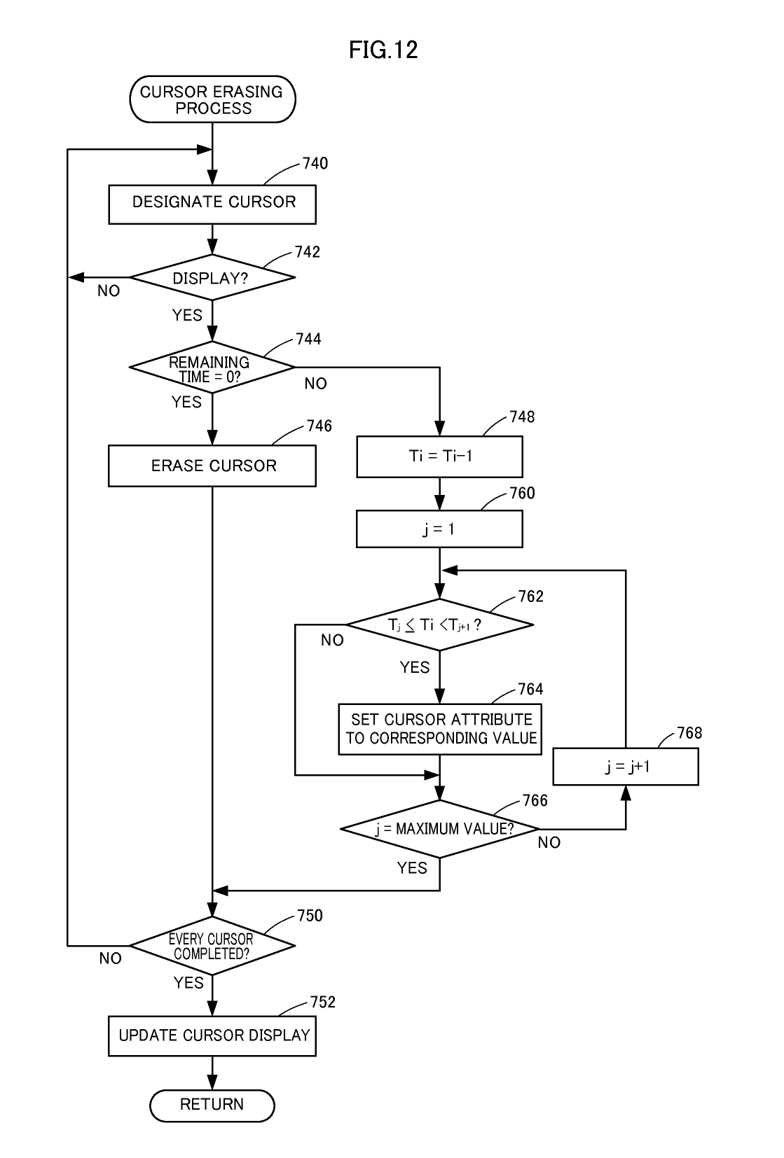

Though an example in which the cursor erasing process is executed by the program shown in FIG. 8 has been described above, it is not limiting. In the cursor erasing process, the attribute (for example, luminance, color or the like) of the cursor may be changed in accordance with the passage of time in which the cursor is left unoperated, as shown in FIG. 12. Here, cursor state (see FIG. 10) of each piece of cursor information stored in RAM 206 additionally includes a value of cursor attribute, and CPU 202 displays the cursor using the value of cursor attribute. Further, it is assumed that the initial value Ts (for example, ten seconds) of remaining time period Ti set at step 714 of FIG. 7 is divided to a plurality (N) of periods, and prescribed cursor attribute values corresponding to respective periods are stored in storage unit 208. If the beginning time (minimum time) of each time period is represented by Tⱼ (where j=1 to N), the time period t of each period is represented as Tⱼ≦t<Tⱼ₊₁, where T₁=0 and T_{N+1}=Ts.

In FIG. 12, process steps denoted by the same reference numbers as in FIG. 8 are the same as those of FIG. 8 and, therefore, accumulative description thereof will not be repeated. FIG. 12 differs from FIG. 8 only in that steps 760 to 768 are added.

Following step 748 of changing the remaining time Ti, at step 760, CPU 202 sets “1” to a counter j for the subsequent repetition process.

At step 762, CPU 202 reads Tⱼ and Tⱼ₊₁ from storage unit 208, and determines whether the remaining time Ti satisfies the relation Tⱼ≦Ti<Tⱼ₊₁. Specifically, it determines whether the remaining time Ti is within the period with the beginning time Tⱼ. If it is determined that the relation Tⱼ≦Ti<Tⱼ₊₁ is satisfied, the control proceeds to step 764. Otherwise, the control proceeds to step 766.

At step 764, CPU 202 reads a value (for example, Lⱼ) corresponding to Tⱼ≦Ti<Tⱼ₊₁ from storage unit 208, and sets the value to be the cursor attribute (for example, luminance) corresponding to the terminal ID designated at step 740.

At step 766, CPU 202 determines whether or not the counter j is equal to or larger than the maximum value N. If it is determined to be equal to or larger than N, the control proceeds to step 750. Otherwise, the control proceeds to step 768.

At step 768, CPU 202 adds “1” to the counter j, and the resulting value becomes the new counter j. Thereafter the control returns to step 762.

In this manner, the steps 762 to 768 are repeated by a prescribed number of times (corresponding to the number of division N of passage time Ts until the cursor is erased), whereby the cursor attribute corresponding to the terminal ID designated at step 740 is determined in accordance with the remaining time Ti.

By way of example, assume that the luminance L of the cursor is to be changed. Here, luminance values Lⱼ (j=1 to N) are stored in association with respective beginning time Tⱼ. Assuming that Ts=10 (seconds), and that this is divided to ten periods of one second each, Tⱼ and Lⱼ are stored as pairs, such as (1, L₁), (2, L₂), . . . , (10, L₁₀). If the luminance values L₁ to L₁₀ are set to be L₁<L₂< . . . <L₁₀, the luminance of cursor is set to be smaller as the remaining time becomes shorter (by the passage of about every second). Therefore, when the cursor display is updated at step 752, a cursor that is constantly operated (of which remaining time Ti is close to the initial value Ts) is displayed with high luminance, while a cursor not operated for a longer time period is displayed with lower luminance. Then, the cursor of which remaining time reached “0” is erased from the display unit 210. Therefore, it is possible for the user to predict how soon a cursor will disappear and, if necessary, it is possible to operate the terminal to prevent disappearance of the cursor.

The cursor attribute is not limited to the luminance, and it may be the color. Specifically, as the time the cursor is left unoperated becomes longer, the color of cursor may be changed. Alternatively, the size of cursor may be used as the attribute, and as the time the cursor is left unoperated becomes longer, the cursor may be displayed in a smaller size.

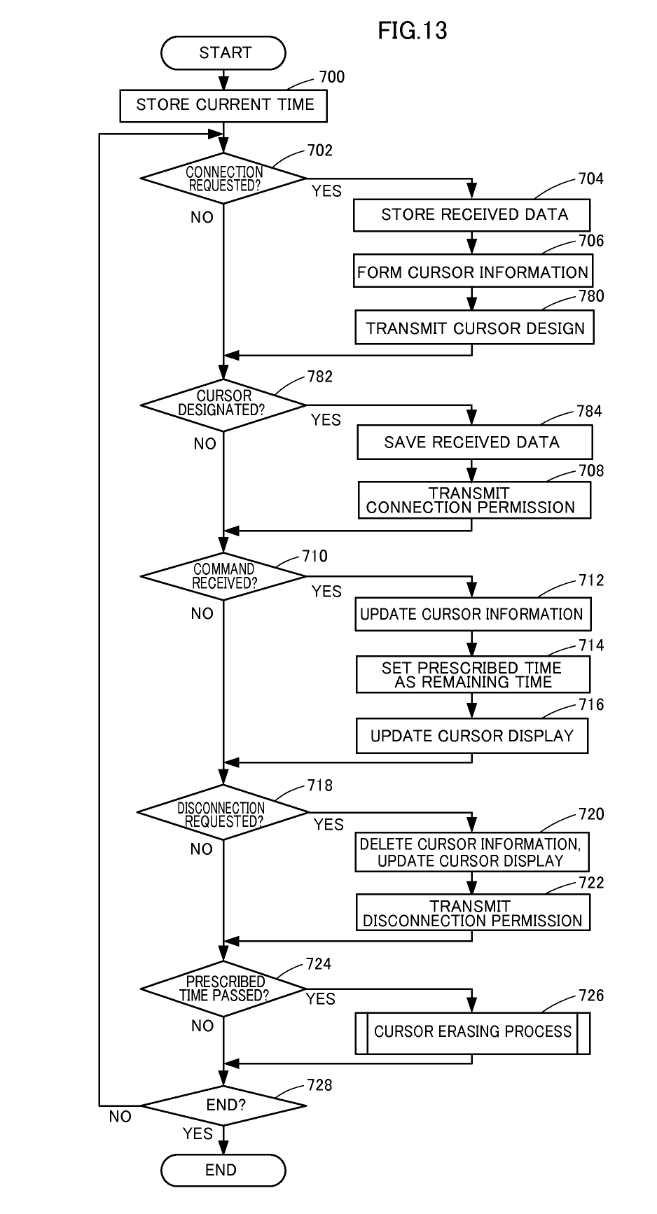

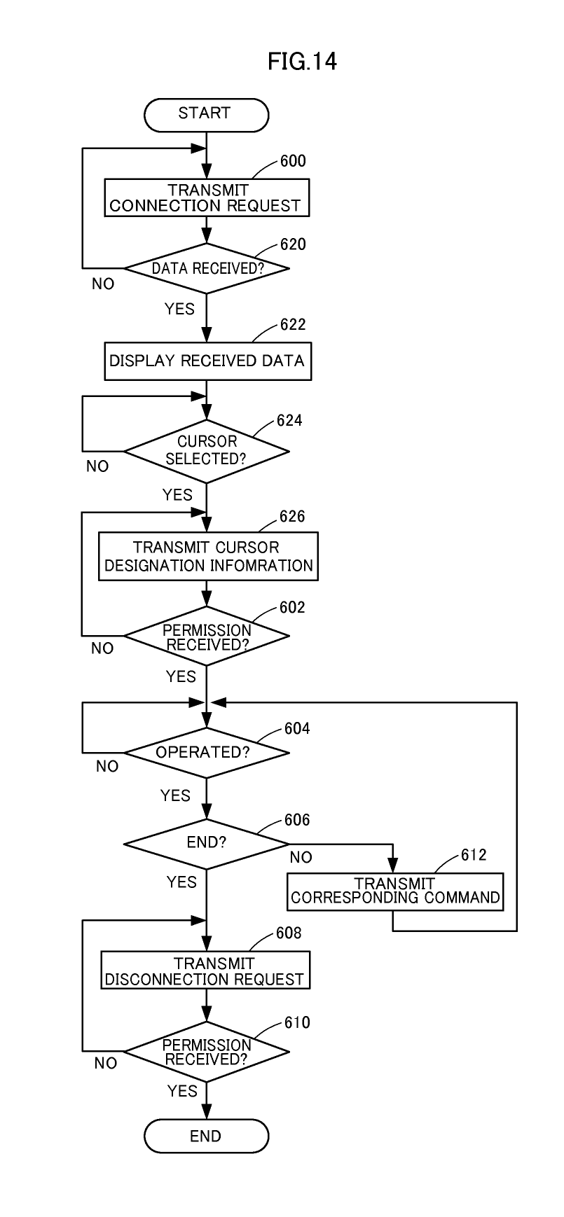

In the foregoing, though an example in which image display apparatus 200 allocates cursor types not overlapping with each other when it receives connection requests from terminals has been described above, it is not limiting. It may be possible to have the user of terminal select the cursor type. By way of example, a program shown in FIG. 13 may be executed in the first terminal 300 and the program shown in FIG. 14 may be executed in image display apparatus 200.

In the flowchart of FIG. 13, the process steps denoted by the same reference numbers as in the flowchart of FIG. 7 are the same as those of FIG. 7. Therefore, accumulative description thereof will not be repeated. FIG. 13 differs from FIG. 7 only in that steps 780 to 784 are added between steps 706 and 708. Further, in the flowchart of FIG. 14, the process steps denoted by the same reference numbers as in the flowchart of FIG. 6 are the same as those of FIG. 6. Therefore, accumulative description thereof will not be repeated. FIG. 14 differs from FIG. 6 only in that steps 620 to 626 are added between steps 600 and 602.

In image display apparatus 200, following step 706 of forming the cursor information, at step 780, CPU 202 transmits data related to the cursor. By way of example, CPU 202 has image data of a plurality of different cursors and data for specifying each of the cursors (hereinafter referred to as cursor ID) stored therein, and in order to allocate cursors not overlapping with each other to terminals requesting connection, it transmits not-yet-allocated image data of a plurality of cursors and cursor IDs to the terminal (the first terminal 300) of which connection request has been received at step 702.

At step 782, CPU 202 determines whether or not data designating a cursor, that is, the cursor ID, has been received. If it is determined that the data has been received, the control proceeds to step 784. Otherwise, the control proceeds to step 710. As will be described later, among the plurality of transmitted cursor image data, data (cursor ID) that specifies the cursor selected by the user is returned.

At step 784, CPU 202 stores the received cursor ID in a prescribed area of RAM 206. Thereafter, step 708 of transmitting the connection permission code is executed.

In the first terminal 300, a process corresponding to the process above is executed. Specifically, referring to FIG. 14, following step 600 of transmitting the connection request command, at step 620, CPU 302 determines, for a prescribed time period, whether or not the cursor image data (data transmitted from CPU 202 at step 780) is received. If it is determined that the cursor image data is received, the control proceeds to step 622. If it is not received within the prescribed time period, the control returns to step 600.

At step 622, CPU 302 displays the received plurality of cursor image data and a message asking selection of a cursor (for example, “Please touch and select a cursor you want to use”) on display unit 310 and waits for the selection by the user.

At step 624, CPU 302 determines whether or not a cursor is selected. If it is determined that the cursor is selected, the control proceeds to step 626. Otherwise, step 624 is repeated.

At step 626, CPU 302 transmits a cursor ID corresponding to the cursor determined to be selected at step 624 to image display apparatus 200. Thereafter, step 602 of determining whether or not the connection permission code is received from image display apparatus 200 is executed.

In this manner, it is possible for the user to select a desired cursor without overlapping.

Though an example has been described above in which the image display apparatus 200 is an electronic blackboard, it is not limiting. The image display apparatus 200 may be a projector or a multi-display apparatus having a plurality of displays arranged to form a large screen.

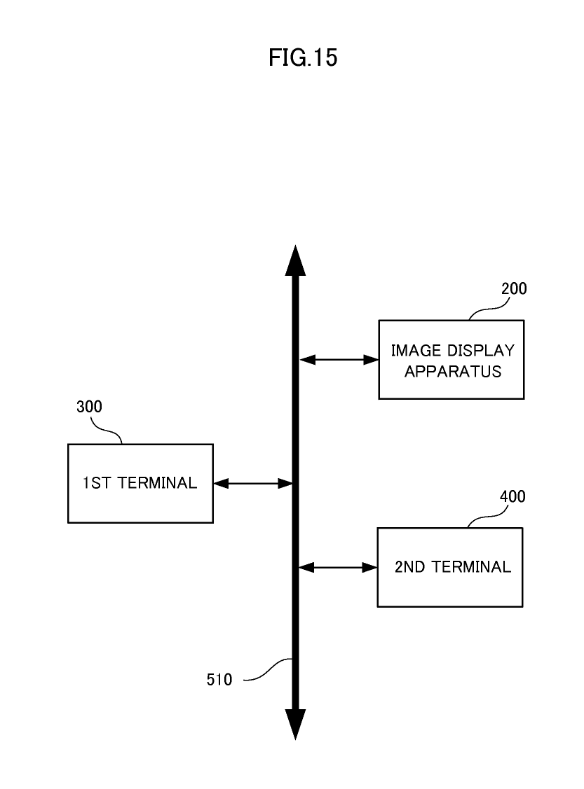

Though an example has been described above in which the first and second terminals 300 and 400 are connected to network 510 by wireless router 500, it is not limiting. The first and second terminals 300 and 400 may be connected by wire to network 510, as shown in FIG. 15.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

### INDUSTRIAL APPLICABILITY

By the present invention, an image display apparatus and an image display system that can automatically erase or re-display a cursor displayed on a screen and that can display a cursor in a special manner different from a normal manner upon reception of a prescribed instruction can be provided.

### DESCRIPTION OF THE REFERENCE SIGNS

100 image display system
200 image display apparatus
202 CPU
204 ROM
206 RAM
208 storage unit
210 display unit
212 display control unit
214 operation unit
216 timer
218 communication IF unit
220 bus
300 first terminal
400 second terminal
500 wireless router
510 communication network

1. An image display apparatus, including a display unit displaying an image and a communication unit communicating with an external device, comprising:
a control unit controlling said display unit; wherein
in response to said communication unit receiving data indicating that said external device is operated, said control unit causes said display unit to display a cursor corresponding to said external device; and
determining that said external device is not operated for a prescribed time period, said control unit causes said display unit to erase the cursor corresponding to said external device.

2. The image display apparatus according to claim 1, further comprising:
a timer for measuring, for every said external device, from reception of the data indicating that said external device is operated, time passed without receiving the data indicating that said external device is operated, until said prescribed time period is elapsed; wherein
said control unit changes attribute of said cursor corresponding to said external device related to display by said display unit, in accordance with said passed time for every said external device measured by said timer.

3. An image display apparatus, including a display unit displaying an image and a communication unit communicating with an external device, comprising:
a control unit controlling said display unit; wherein
in response to said communication unit receiving data indicating that said external device received a prescribed operation, said control unit changes attribute of said cursor corresponding to said external device related to display by said display unit.

4. The image display apparatus according to claim 3, wherein
said external device has an input unit detecting a touched position; and
said prescribed operation is an operation of successively touching said input unit along a prescribed track.

5. The image display apparatus according to claim 3, wherein said prescribed operation is an operation of changing position or inclination of said external device.

6. An image display system including an image display apparatus and an external device capable of communicating with said image display apparatus, wherein
said external device includes a transmitting unit transmitting, to said image display unit, request data requesting display of a cursor;
said image display apparatus includes
a display unit displaying an image,
a communication unit communicating with said external device, and
a control unit controlling said display unit;
when said external device is operated, said transmitting unit transmits operation data corresponding to the operation to said image display apparatus;
in response to said communication unit receiving said operation data from said external device, said control unit causes said display unit to display a cursor corresponding to said external device; and
determining that said external device is not operated for a prescribed time period, said control unit causes said display unit to erase the cursor corresponding to said external device.
